(19) United States
(12) Patent Application Publication
(10) Pub. No.: US 2015/0200883 A1
(43) Pub. Date: Jul. 16, 2015

(54) SYSTEMS AND METHODS FOR MAINTAINING RESPONSIVENESS IN THE PRESENCE OF LARGE DATA CHUNKS

(71) Applicants: Daniel Scott Brotherston, Ontario (CA); Matthew Bolohan, Ontario (CA); Nathan Bullock, Ontario (CA)

(72) Inventors: Daniel Scott Brotherston, Ontario (CA); Matthew Bolohan, Ontario (CA); Nathan Bullock, Ontario (CA)

(21) Appl. No.: 13/483,539

(22) Filed: May 30, 2012

(51) Int. Cl. H04L 12/58; H04L 12/26

(52) U.S. Cl. CPC H04L 51/08; H04L 51/046; H04L 43/16

(57) ABSTRACT

Embodiments relate to methods, devices, and computer-implemented methods for determining if an email attachment to be transmitted by an application on the mobile computing device to another computing device on a first data channel exceeds a predetermined size threshold; determining if the email attachment is independent of other active email attachment requests on the first data channel; providing the email attachment over the first data channel if the size is determined not to exceed the predetermined size threshold; providing the email attachment over the first data channel if the email attachment is determined to be dependent of the other active email attachment, requests; and providing the email attachment over a second data channel different than the first data channel if the size is determined to be above the predetermined size threshold and is independent of the other active email attachment requests.

### TECHNICAL FIELD

The present teachings relate to systems and methods for email application operating on mobile computing devices, and more particularly, to platforms and techniques for maintaining responsiveness of email applications in the presence of large data chunks.

### BACKGROUND

Mobile computing devices, such as smart phones, typically include communication tools, such as email applications, that allow users to access a variety of public, private and/or corporate email systems over a variety of wired and wireless communication networks. Each communication network has a finite ability to allow uplink/upload and downlink/download capability for each user of the mobile computing devices in the network due to bandwidth and data rate limits inherent in the network and in the mobile devices. The transmission of larger uploads onto uplink/upload channels of the network, such as when a user attaches one or more email attachments, i.e., video, picture, sound, programs, executable files, as well as other file types that can be transmitted using an email application, can cause a poor user experience. This can be due to a decrease in system responsiveness that can occur from to the limitations of the bandwidth and data rate limits for the communication network and/or data channels of the particular network when large file are being transmitted. Typically, a single data or communication channel is used for uploads onto the network, which can be acceptable for some files, but can become a bottleneck for larger files being uploaded and transmitted on the network. This bottlenecking can also impact other functions of the email application, such as data reception, maintenance activities such as synching to another computer, composing emails, appointments and other general email tasks that are made available by the email application. An improvement to the operation of conventional email applications would be desired to address these issues.

### SUMMARY

In accordance with aspects of the present disclosure, a computer-implemented method is disclosed. The computer-implemented method can comprise determining, by at least one processor of a mobile computing device, if an email attachment to be transmitted by an application on the mobile computing device to another computing device on a first data channel exceeds a predetermined size threshold; determining, by the at least one processor of the mobile computing device, if the email attachment is independent of other active email attachment requests on the first data channel; providing the email attachment over the first data channel if the size is determined not to exceed the predetermined size threshold; providing the email attachment over the first data channel if the email attachment is determined to be dependent of the other active email attachment requests; and providing the email attachment over a second data channel different than the first data channel if the size is determined to be above the predetermined size threshold and is independent of the other active email attachment requests.

In accordance with aspects of the present disclosure, a device is disclosed that can comprise at least one processor; and a non-transitory computer readable medium comprising instructions that cause the at least one processor to perform a method comprising: determining if an email attachment to be transmitted by an application on a mobile computing device to another computing device on a first data channel exceeds a predetermined size threshold; determining if the email attachment is independent of other active email attachment requests on the first data channel; provide the email attachment over the first data channel if the size is determined not to exceed the predetermined size threshold; providing the email attachment over the first data channel if the email attachment is determined to be dependent on the other active email attachment requests; and providing the email attachment over a second data channel different than the first data channel if the size is determined to be above the predetermined size threshold and is independent of the other active email attachment requests.

In accordance with aspects of the present disclosure, a computer readable storage medium is disclosed. The computer readable storage medium can comprise instruction that cause one or more processors to perform a method comprising determining if an email attachment to be transmitted by an application on a mobile computing device to another computing device on a first data channel exceeds a predetermined size threshold; determining if the email attachment is independent of other active email attachment requests on the first data channel; provide the email attachment over the first data channel if the size is determined not to exceed the predetermined size threshold; providing the email attachment over the first data channel if the email attachment is determined to be dependent on the other active email attachment requests; and providing the email attachment over a second data channel different than the first data channel if the size is determined to be above the predetermined size threshold and is independent of the other active email attachment requests.

In some aspects, the method, device and the computer readable storage medium can further comprise formatting, by the processor, the email attachment into one or more data packets suitable for transmission over the first data channel, the second data channel, or both the first and the second data channel.

In some aspects, the first data channel can be a primary data channel for sending and receiving the email attachment by the application. In some aspects, the second data channel can be an auxiliary data channel for sending the email attachment by the application if the email attachment exceeds the predetermined size threshold and is independent of the other active email attachment requests.

In some aspects, the application can comprise an email application, a social networking application, or a file sharing application.

In some aspects, the email attachment can be independent of other email attachment request if the email attachment does not need any of the other email attachment requests to maintain data consistency between the mobile computing device and an email server.

In some aspects, the predetermined size threshold can be dynamically modified by the mobile computing device.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 illustrates an example block diagram illustrating a system according to various embodiments;

FIG. 2 illustrates an example flowchart according to Various embodiments; and

FIG. 3 illustrates an example block diagram illustrating an internal architecture of the device according to various embodiments.

### DESCRIPTION OF EMBODIMENTS

Embodiments of the present teachings generally relate to methods, devices, and computer-implemented methods for determining if data, such as ah email attachment or a set of email attachments, exceeds a predetermined size threshold and is related to or dependent on other active data requests from an application and providing the data over one or more data communication channels, The application can include application such as email, social networking, and file sharing applications where data, such as pictures, videos, sound, and other application files can be transmitted and/or received from other computing devices.

For example, separate email attachments can be transmitted over one or more data channels that are different than the data channels used for data downloads and uploads. This separation can be achieved by determining if the email attachment, if transmitted over the data channels used for data downloads would cause undue delay to either uploads or downloads to the mobile computing device. For example, if a particular email attachment is unrelated to or independent of any data requests being made by the email system and is over a predetermined size threshold, the attachment can be transmitted over different data channels than the data channels used for other uploads or downloads from the mobile computing device. For example, a primary data channel can be used for data that does not exceed a predetermined size threshold and a secondary or any other auxiliary data channel(s) can be used for data is determined to exceed the predetermined size threshold and are unrelated (independent) to other pending data requests by the system or application that is or can be transmitted on the primary channel.

By way of a non-liming example, the secondary or auxiliary data channel could be used for any data that is independent of the normal data that is being sent over the primary data channel; For example, the secondary channel can be used for any logging/impressions/usage data. The primary channel can bemused for anything that is latency sensitive. The second channel can be used for data transmission that is not latency sensitive and which is not dependent on data on the primary channel.

Embodiments discussed below will describe an example application in accordance with the teachings described herein in terms of an email application operating on a mobile computing device. The email application is only one type of application that can be used. As discussed above, applications can include other applications were data is produced and/or received and which can be formatted for transmission over one or more data channels to other computing devices.

Reference will now be made in detail to exemplary embodiments of the present teachings, which are illustrated in the accompanying drawings. Where possible the same reference numbers will be used throughout the drawings to refer to the same or like parts.

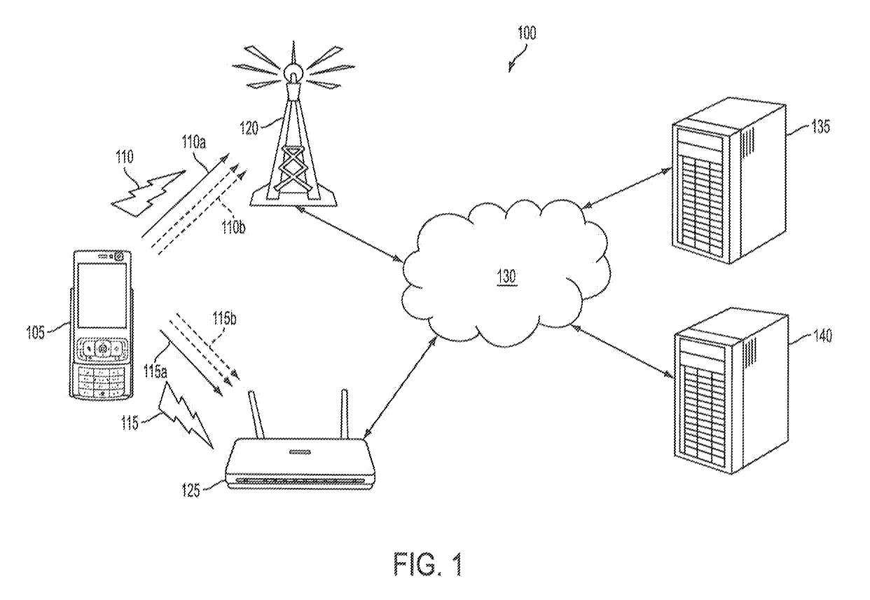

FIG. 1 is a example block diagram illustrating a system arranged perform the functions or operations of separating large data, such as email attachment uploads, into a format suitable for transmission over one or more communication channel uplinks or upload channels can operate, according to aspects. It should be readily apparent to one of ordinary skill in the art that the system depicted in FIG. 1 represents a generalized schematic illustration and that other components/devices can be added, removed, or modified.

Referring to Figured, a simplified example communication network 100 is illustrated generally. For simplicity, Various network infrastructure (e.g. for wireless carriers and enterprises, including gateways, firewalls, etc.), application gateways/gateway servers, provisioning servers, discovery servers, and application repositories are not shown, but can be included in network 100 as would be understood by those skilled in the art. Communication network 100 can comprise mobile wireless communication device, or simply mobile device 105, coupled for wireless communication via at least one wifeless communication network (e.g. 110 and 115) to at least one of a plurality of backend servers 135 and 140. For simplicity, the drawings and description refer to a single mobile wireless communication device 105 whereas in practice and as would be understood to a person of ordinary skill, a plurality of such devices are typically present in the network 100. A particular mobile device 105 may comprise various computing devices such as a desktop computer, a laptop or other portable computer, a smart phone, a personal digital assistant (PDA), and the like.

In the example network 100, mobile device 105 can be capable of wireless communication in accordance with WLAN or WMAN (e.g. Wi-Fi or WiMAX) and WWAN (e.g. GSM Cellular) standards. As such, it may communicate through cellular network 110 and base station 120 coupled to network 130, such as the Internet and/or through WLAN or WMAN network 115 and access point 125 also coupled to network 130. Servers 135 and 140 can also coupled to network 130. Network 110 can comprise primary communication channel 110a (solid line) and one or more auxiliary communication channels 110b (dotted line) and network 115 can comprise primary communication channel 115a (solid line) and one or more auxiliary communication channels 115b (dotted line). Though shown as communicating through the public network 130, such as the Internet, other network configurations will be apparent to persons of ordinary skill in the art. For example, one or more backend servers 135 and 140 may be accessible to device 105 over a LAN, such as ah enterprise LAN (not shown).

In some aspects, the activation of the one or more auxiliary data channels can be done on an on-demand basis (i.e. not over a subscribed line). In some aspects, the routing logic used to determine usage between the primary and auxiliary channels and/or file size determining logic used to determine file size can be hosted in the device, in a wireless server, or someplace else within or outside of the network.

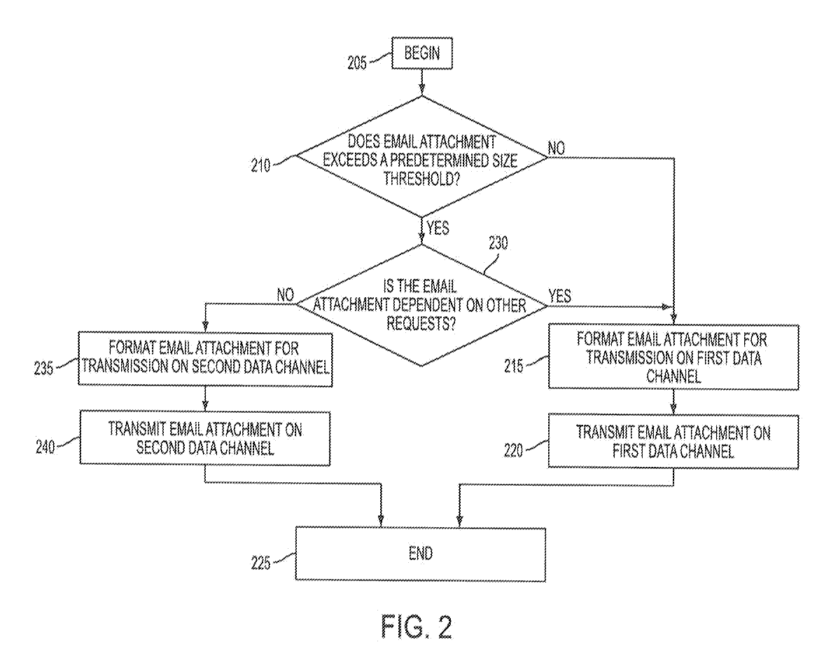

FIG. 2 illustrates a flowchart of the separation analysis and other processing that can be performed on email attachment uploads systems and methods for separating large upload email attachments for transmission on one or more data channels that are different than data channels used for or reserved for data downloads, according to aspects. In 205, processing can begin. In 210, separation engine and/or other logic, platforms, applications, and/or services can be invoked on the mobile computing device to in response to an email message being constructed on a mobile email messaging application. The separation engine and/or other logic, platforms, applications, and/or services can perform a determination as to whether one or more email attachments exceed a predetermined file size threshold. The determination can be based on the total file, size of all email attachments for a particular email message or any file size of any individual email attachment. The predetermined file size threshold can be set or adjusted based on the particular email application, mobile computing device or network constraints or requirements. For example, the predetermined file size threshold can be set or adjusted by the user or network administrator for a particular email message or email session. The predetermined file size threshold can be, for example, about 1, 10, 20, 50 or 100 MB.

In 215, if the result of the determination in 210 is negative, meaning that the file size of the email attachments do not exceed the predetermined file size threshold, then the separation engine and/or other logic, platforms, applications, and/or services can format and/or prepare the email message with the email attachments for transmission over one data channel, for example, the first data channel, without causing undue constraints, delays or slower responsiveness of the email application. In 220, the email attachments can be transmitted over the first data channel.

In 230, if the result of the determination in 210 is positive, meaning that the file size of the email attachments exceeds the predetermined file size threshold, then the separation engine and/or other logic, platforms, applications, and/or services can perform a determination as to whether the one or more email attachments are related or dependent on one or more pending data requests from the mobile computing device. For example, the one or more data requests can be associated with another data channel used or reserved for data downloads or data uploads. By way of another non-limiting example, the determination can be based on whether the email attachments are related or dependent on email application maintenance tasks being performed or scheduled to be performed or email drafts being constructed. The relatedness or dependence can be based on, for example, a destination file or email server or intended recipient of the email message. In some aspects, the email attachments can be determined to be independent of other email attachment request if the email attachment does hot need any of the other email attachment requests to maintain data consistency between the mobile computing device and an email server.

If the result of the determination in 230 is positive, meaning that the email attachment request are dependent, then the separation engine and/or other logic, platforms, applications, and/or services can proceed to 215, where the email attachment is formatted for transmission on the first data channel, and then to 220, where the email attachment is transmitted over the first data channel.

If the result of the determination in 230 is negative, meaning that the email attachment is independent on other email attachment requests from the mobile computing system, then the separation engine and/or other logic, platforms, applications, and/or services can prepare and/or format in 235 the one or more email/attachments for transmission in 240 onto one or more upload, data channels, for example, the second data channel. In 225, the process can end.

By way of a non-limiting example of various networks that may be used in accordance with aspects of the present disclosure, WiFi (using one of the many IEEE 802.11 standards) consists of unlicensed channels 1-13 from 2412 MHz to 2484 MHz in 5 MHz steps. If the email attachment, as determined by 220, is less than the predetermined file size, then it can be prepared and formatted for transmission onto channel 1. If, however, the email attachment exceeds the file size test at 220 and is not dependent on one or more data requests from the mobile computing device, as determined by 240, the email attachment can be prepared and formatted for transmission onto brie or more other channels in addition to or alternatively to channel 1, such as one or more of channels in the range of 2-13.

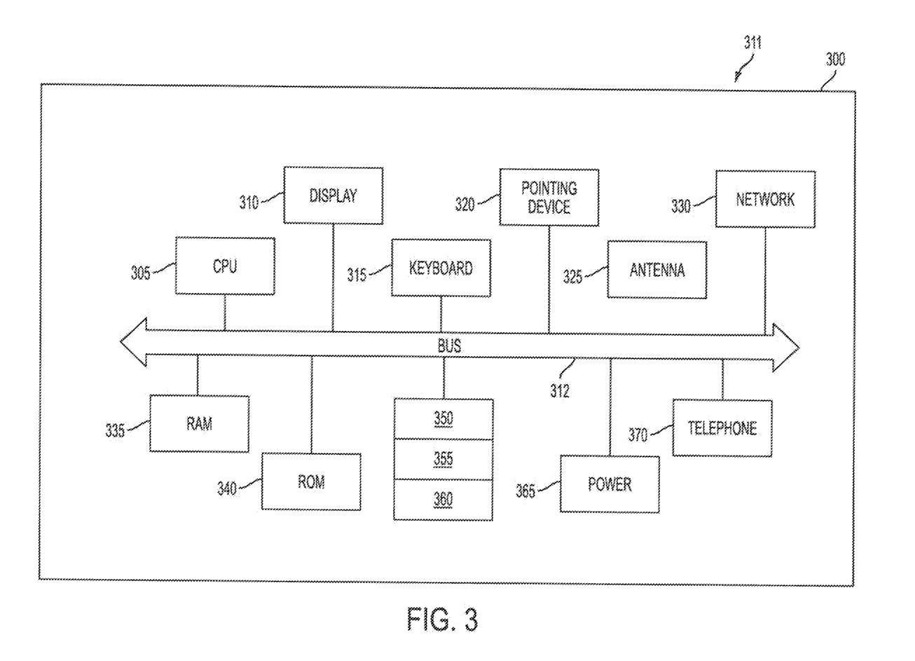

FIG. 3 is a example block diagram illustrating an internal architecture 300 of device 311 arranged perform the functions or operations of separating large email attachment uploads into a format suitable for transmission over one or more communication channel uplinks or upload channels can operate, according to aspects. It should be readily apparent to one of ordinary skill in the art that the device depicted in FIG. 3 represents a generalized schematic illustration and that other components/devices can be added, removed, or modified.

Referring to FIG. 3, the architecture can include central processing unit (CPU) 105 where the computer instructions that comprise an operating system or an application are processed; display interface 110 that provides a communication interface and processing functions for rendering video, graphics, images, and texts on display, provides a set of built-in controls (such as buttons, text and lists), and supports diverse screen sizes; keyboard interface 315 that provides a communication interface to keyboard; pointing device interface 320 that provides a communication interface to pointing device; antenna interface 325 that provides a communication interface to antenna; network connection interface 330 that provides a communication interface to a network over computer network connection; random access memory (RAM) 335 where computer instructions and data are stored in a volatile memory device for processing by CPU 305; read-only memory (ROM) 340 where invariant low-level systems code or data for basic system functions such as basic input and output (I/O), startup, or reception of keystrokes from keyboard are stored in a non-volatile memory device; storage medium 345 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files that comprise an operating system 350, application programs 355 including, for example, web browser application, email application and/or other applications, and data files 360 are stored; power source 365 that provides an appropriate alternating current (AC) or direct current (DC) to power components; telephony subsystem 370 that allows the device to transmit and receive sound over a telephone network; and bus 312 that allows communication among the various components of device.

Device 311 can be arranged to operate using a variety of wireless communication systems to provide various telecommunication services such as telephony, video, data, messaging, and broadcasts. The wireless communication systems can include multiple-access technologies, which are capable of supporting communication with multiple users by sharing available system resources (e.g., bandwidth, transmit power). Examples of such that can function with device 100 include multiple-access technologies include code, division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, time division synchronous code division multiple access (TD-SCDMA) systems, worldwide interoperability for microwave access (WiMAX), and Long Term Evolution (LTE).

As used herein, the terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. Moreover, the networks and systems can include physical networks, virtual networks, cloud networks, clusters, sub-nets, partitions, etc. For example, data transmitted by device can be arranged to be transmitted on a primary or one or more auxiliary data channels through one or more cloud networks.

Device 311 can communicate with one or more base stations via transmissions on the forward and reverse links. The forward link or downlink (DL) refers to the communication link from the base stations to the terminals, and the reverse link or uplink (UL) refers to the communication link from the terminals to the base stations. This communication link may be established via a single-in-single-out, multiple-in-single-out, or a multiple-in-multiple-out (MIMO) system. A MIMO system employs multiple transmit antennas and multiple receive antennas for data transmission. A MiMO channel formed by the transmit and receive antennas may be decomposed into a number of independent channels, which are also referred to as spatial channels.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory; registers, hard disk, a removable disk; a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions of code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, of other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc Where disks usually reproduce data magnetically, while discs reproduce data optically with lasers. Combinations of the above should also be included within the scope of computer-readable media.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one haying skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also fee understood by one skilled in the art all language such as “up to,” “at least,” “greater than,” “less than,” and the like include the number recited and refer to ranges Which can be subsequently broken down into subranges as discussed above. Finally, as will be understood by one skilled in the art, a range includes each individual member. Thus, for example, a group having 1-3 cells refers to groups haying 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are hot intended to be limiting, with the true scope and spirit being indicated by the following claims.

1. A computer-implemented method comprising: determining, by at least one processor of a mobile computing device, if an email
attachment for an email message to be transmitted by an application on the mobile computing device to another computing device on a first data channel exceeds a predetermined size threshold;
determining, by the at least one processor of the mobile computing device, if the email attachment is independent of other active email attachment requests on the first data channel;
providing the email attachment with the email message over the first data channel if the size is determined not to exceed the predetermined size threshold;
providing the email attachment with the email message over the first data channel if the email attachment is determined to be dependent of the other active email attachment requests; and
providing the email attachment separately from the email message over a second data channel different than the first data channel if the size is determined to be above the predetermined size threshold and is independent of the other active email attachment requests.

2. The computer-implemented method according to claim 1, further comprising formatting, by the processor, the email attachment into one or more data packets suitable for transmission over the first data channel, the second data channel, or both the first and the second data channel.

3. The computer-implemented method according to claim 1, wherein the first data channel is a primary data channel for sending and receiving the email attachment by the application.

4. The computer-implemented method according to claim 1, wherein the second data channel is an auxiliary data channel for sending the email attachment by the application if the email attachment exceeds the predetermined size threshold and is independent of the other active email attachment requests.

5. The computer-implemented method according to claim 1, wherein the application comprises an email application, a social networking application, or a file sharing application.

6. The computer-implemented method according to claim 1, wherein the email attachment is independent of other email attachment request if the email attachment does not need any of the other email attachment requests to maintain data consistency between the mobile computing device and an email server.

7. The computer-implemented method according to claim 1, wherein the predetermined size threshold can be dynamically modified by the mobile computing device.

8. A device comprising:
at least one processor; and
a non-transitory computer readable medium comprising instructions that cause the at least one processor to perform a method comprising:
determining if an email attachment for an email message to be transmitted by an application on a mobile computing device to another computing device on a first data channel exceeds a predetermined size threshold;
determining if the email attachment is independent of other active email attachment requests on the first data channel;
providing the email attachment with the email message over the first data channel if the size is determined not to exceed the predetermined size threshold;
provide the email attachment with the email message over the first data channel if the email attachment is determined to be dependent on the other active email attachment requests; and
providing the email attachment separately from the email message over a second data channel different than the first data channel if the size is determined to be above the predetermined size threshold and is independent of the other active email attachment requests.

9. The device according to claim 8, wherein the processor is arranged to format the email attachment into one or more data packets suitable for transmission over the first data channel, the second data channel, or both the first and the second data channel.

10. The device according to claim 9, wherein the first data channel is a primary data channel for sending and receiving the one or more data packets by the application.

11. The device according to claim 9, wherein the second data channel is an auxiliary data channel for sending the one or more data packets by the application if the email attachment exceeds the predetermined size threshold and is independent of the other active email attachment requests.

12. The device according to claim 9, wherein the application comprises an email application, a social networking application, or a file sharing application.

13. The device according to claim 9, wherein the email attachment is independent of other email attachment request if the email attachment does not need any of the other email attachment requests to maintain data consistency between the mobile computing device and an email server.

14. The device according to claim 9, wherein the predetermined size threshold can be dynamically modified by the mobile computing device.

15. A non-transitory computer readable storage medium storing instruction that cause one or more processors to perform a method comprising:
determining if an email attachment for an email message to be transmitted by an application on a mobile computing device to another computing device on a first data channel exceeds a predetermined size threshold;
determining if the email attachment is independent of other active email attachment requests on the first data channel;
providing the email attachment with the email message over the first data channel if the size is determined not to exceed the predetermined size threshold;
provide the email attachment with the email message over the first data channel if the email attachment is determined to be dependent on the other active email attachment requests; and
providing the email attachment separately from the email message over a second data channel different than the first data channel if the size is determined to be above the predetermined size threshold and is independent of the other active email attachment requests.

16. The non-transitory computer readable storage medium according to claim 15, wherein the email attachment is operable to be formatted by the one or more processors into one or more data packets suitable for transmission over the first data channel, the second data channel, or both the first and the second data channel.

17. The non-transitory computer readable storage medium according to claim 15, wherein the first data channel is a primary data channel for sending and receiving the email attachment by the application.

18. The non-transitory computer readable storage medium according to claim 16, wherein the second data channel is an auxiliary data channel for sending the one or more data packets by the application if the email attachment exceeds the predetermined size threshold and is independent of the other active email attachment requests.

19. The non-transitory computer readable storage medium according to claim 15, wherein the application comprises an email application, a social networking application, or a file sharing application.

20. The non-transitory computer readable storage medium according to claim 15, wherein the email attachment is independent of other email attachment request if the email attachment does not need any of the other email attachment requests to maintain data consistency between the mobile computing device and an email server.
